(19) United States
(12) Patent Application Publication
(10) Pub. No.: US 2026/0260048 A1
(43) Pub. Date: Sep. 3, 2026

(54) SYSTEMS AND METHODS FOR STRUCTURED GATE OPTIMIZATION IN DIGITAL CIRCUITS

(71) Applicant: V.I.E.E. LLC, Shelburne, VT (US)

(72) Inventors: Sebastian T. VENTRONE, South Burlington, VT (US); Hayden Clavie CRANFORD, JR., Cary, NC (US)

(21) Appl. No.: 19/550,638

(22) Filed: Feb. 26, 2026

Related U.S. Application Data
(60) Provisional application No. 63/766,053, filed on Mar. 3, 2025.

(51) Int. Cl. G06F 30/337; G06F 17/10

(52) U.S. Cl. CPC G06F 30/337; G06F 17/10

(57) ABSTRACT

A methodology for optimizing digital circuits by identifying recurring multi-gate logic structures within a gate-level representation, performing constraint-bounded Boolean reduction, and replacing such structures with validated structured gates. The approach enables improvements in area, performance, and power consumption while maintaining compatibility with target manufacturing technologies.

### TECHNICAL FIELD

The present invention relates generally to digital circuit design and optimization. More particularly, the invention relates to techniques for identifying inefficient gate-level logic structures and replacing such structures with Boolean-equivalent structured circuits to improve performance, reduce power consumption, and reduce silicon area.

### BACKGROUND

Modern integrated circuit designs rely heavily on predefined standard cell libraries and conventional electronic design automation flows. These flows typically include logic synthesis, placement, routing, and incremental optimization stages. While such tools are effective for producing functionally correct designs, their optimization capabilities are inherently constrained by the logic, timing, power, and physical characteristics of the available logic cell libraries.

Existing approaches to digital circuit optimization address isolated aspects of the design process, including logic representation, Boolean optimization, timing analysis, congestion management, and physical verification. Some techniques employ technology-independent logic representations to perform Boolean manipulation prior to mapping, while others apply heuristic Boolean reduction or incremental optimizations guided by physical metrics such as wiring congestion or timing slack. Still other approaches focus on analysis or verification of logic groupings without altering the underlying physical implementation.

However, these approaches generally operate within the confines of an existing library and do not provide a systematic mechanism for detecting recurring multi-gate logic structures within a completed or partially completed design and replacing such structures with newly generated, Boolean-equivalent circuits. In particular, known methods do not combine identification of recurring multi-gate subgraphs, constraint-bounded Boolean reduction, physical circuit generation subject to manufacturability constraints, and replacement of the original logic structures within the digital circuit.

As a result, inefficiencies introduced by the repeated use of generic library cells often persist throughout a design, even when such inefficiencies are structurally redundant, timing-critical, or power-significant. There remains a need for a methodology that operates on a gate-level representation of a digital circuit to identify reusable multi-gate logic structures, reduce their Boolean complexity within physical constraints, generate validated structured circuits, and integrate those circuits back into the design to improve area, performance, and power consumption while maintaining compatibility with target manufacturing technologies.

### SUMMARY OF THE INVENTION

The Intelligent Layer Compression (V-ILC) methodology provides a structured approach for optimizing digital circuits by identifying recurring gate-level logic structures and replacing such structures with Boolean-equivalent structured circuits generated subject to physical and manufacturability constraints.

In various embodiments, a gate-level representation of a digital circuit is parsed into a graph representation in which nodes correspond to logic gates and edges correspond to signal interconnections. Reusable logic structures comprising recurring multi-gate subgraphs are identified within the graph. Identified structures may be canonicalized to detect logical equivalence independent of placement, orientation, or local implementation differences.

A subset of the identified reusable logic structures is selected for optimization based on one or more design objectives, which may include timing impact, power consumption, silicon area, switching activity, or combinations thereof. For selected structures, a Boolean representation is derived that captures the functional behavior of the multi-gate logic structure independent of its original gate-level implementation.

The Boolean representation is reduced subject to one or more constraints to produce a reduced Boolean representation that preserves functional equivalence while reducing logical complexity. Structured circuits implementing the reduced Boolean representation are generated in accordance with physical, electrical, and manufacturability constraints associated with a target technology.

Generated structured circuits are validated to confirm Boolean equivalence and compliance with applicable design constraints prior to replacement. Upon validation, instances of the selected reusable logic structures within the digital circuit are replaced with the corresponding structured circuits to produce an optimized digital circuit design.

The resulting optimized digital circuit may exhibit reduced silicon area, improved performance, reduced power consumption, or combinations thereof, while maintaining compatibility with existing semiconductor manufacturing processes and design flows. In accordance with an aspect of the disclosure, a computer-implemented method for optimizing a digital circuit design, comprises: parsing a gate-level representation of the digital circuit design into a graph representation; identifying, within the graph representation, a plurality of candidate logic structures each comprising a recurring multi-gate subgraph; selecting at least one candidate logic structure of the plurality of candidate logic structures for optimization based on one or more optimization criteria; deriving a Boolean representation for the selected candidate logic structure; performing Boolean reduction on the Boolean representation to produce a reduced Boolean representation; generating a structured gate configured to implement the reduced Boolean representation; and replacing an instance of the selected candidate logic structure in the digital circuit design with the structured gate to produce an optimized digital circuit design.

In accordance with an aspect of the disclosure, a method comprises: selecting a subset of a logic device layout; generating Boolean equations from the subset of a logic device layout; performing a Boolean reduction on the Boolean equations to obtain a Boolean reduced function; and generating a new logic device layout which is equivalent to the subset of the logic device layout from the Boolean reduced function.

### BRIEF DESCRIPTION OF THE DRAWINGS

FIG. 1 illustrates an example physical and device-level context used in generating structured circuits, including power supply connections, well structures, and layer shape parameters that constrain circuit generation.

FIG. 2 illustrates an embodiment of a circuit generation process in which structured circuits are generated based on Boolean logic representations and associated layer shape parameters.

FIG. 3 illustrates an example of Boolean reduction and mapping of a plurality of interconnected logic gates into a structured circuit that is Boolean-equivalent to the original multi-gate logic structure.

FIG. 4 illustrates an embodiment of an Intelligent Layer Compression (ILC) process flow for identifying reusable logic structures, performing Boolean reduction, generating structured circuits, and replacing selected logic structures within a digital circuit.

FIG. 5 depicts a computer infrastructure according to an embodiment of the present invention.

### DETAILED DESCRIPTION

The Intelligent Layer Compression (V-ILC) methodology operates on a gate-level representation of a digital circuit to identify, reduce, and replace reusable logic structures while preserving Boolean equivalence and manufacturability. In various embodiments, the methodology may be applied to a synthesized netlist, a placed-and-routed design, or a partially optimized digital circuit representation.

The present invention may be a system, a method, and/or a computer program product at any possible technical detail level of integration. The computer program product may include an electronic circuit, a computer readable storage medium (or media) having computer readable program instructions thereon for causing a processor to carry out aspects of the present invention.

As used herein, a “reusable logic structure” refers to a group of interconnected logic gates forming a multi-gate subgraph within a digital circuit. A reusable logic structure may represent a recurring functional pattern, a timing-critical structure, a power-significant structure, or combinations thereof. A “structured circuit” refers to a circuit-level implementation generated to realize a reduced Boolean representation of a reusable logic structure while satisfying one or more physical, electrical, or manufacturability constraints.

In various embodiments, reusable logic structures may include two-level structures referred to as Twigs and multi-level structures referred to as Branches. Twigs may comprise pairs of interconnected logic gates, while Branches may comprise three or more interconnected Twigs forming deeper logic structures. The use of Twigs and Branches is illustrative and does not limit the scope of reusable logic structures that may be identified and optimized.

Aspects of the present invention are also described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

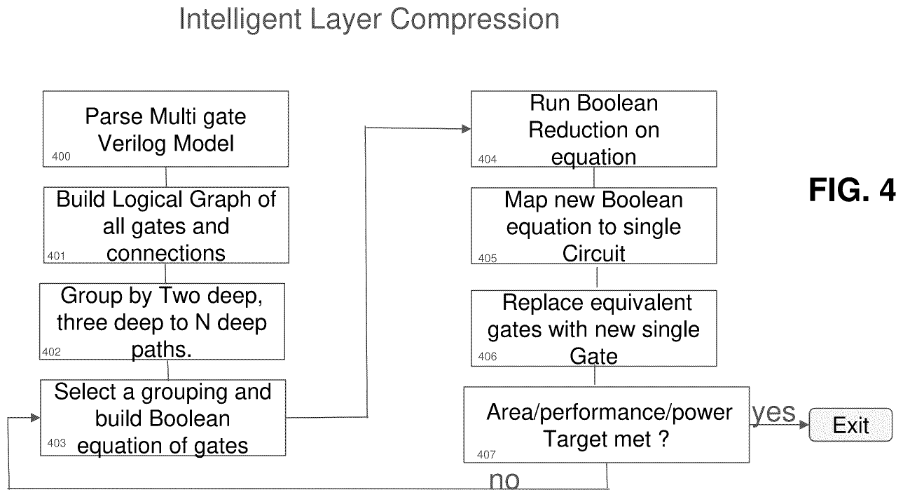

FIG. 4 illustrates an embodiment of an Intelligent Layer Compression (ILC) process flow for identifying reusable logic structures, performing Boolean reduction, generating structured circuits, and replacing selected logic structures within a digital circuit. More specifically and referring to FIG. 4, a digital circuit may be provided in the form of a multi-gate logic description at step 401. The logic description at step 401 may be parsed to construct a logical graph at step 402 in which nodes represent logic gates and edges represent signal interconnections. This graph representation enables analysis of connectivity, structural similarity, and logic depth across the digital circuit.

The logical graph at step 402 may be analyzed to identify reusable logic structures at step 403. In various embodiments, identification may be based on structural repetition, logical equivalence, fan-in and fan-out characteristics, timing criticality, power consumption, switching activity, or combinations thereof. Identified reusable logic structures may optionally be canonicalized to detect logical equivalence independent of placement, orientation, or local implementation differences.

Once identified, a subset of reusable logic structures at step 403 may be selected for optimization based on one or more optimization objectives. Such objectives may include timing improvement, power reduction, silicon area reduction, or overall design efficiency. Selection may be guided by timing reports, power analysis data, or other design metrics.

For a selected reusable logic structure at step 403, a Boolean representation at step 404 may be derived that captures the functional behavior of the multi-gate logic structure independent of its original gate-level implementation. The Boolean representation may then be reduced using one or more Boolean minimization techniques to generate a reduced Boolean representation at step 405 that preserves functional equivalence while reducing logical complexity.

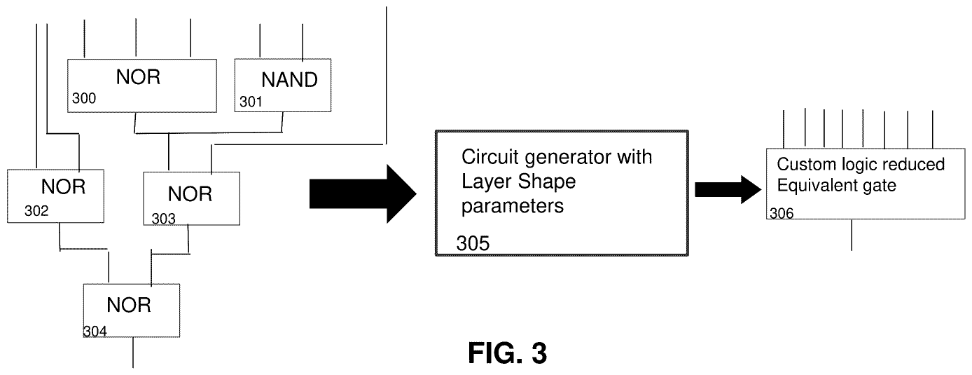

FIG. 3 illustrates an example of Boolean reduction and mapping of a plurality of interconnected logic gates into a structured circuit that is Boolean-equivalent to the original multi-gate logic structure. FIG. 3 may equally represent a flow process or block diagram implementing aspects of the present invention.

Referring to FIG. 3, a structured circuit 304 may be generated to implement the reduced Boolean representation 303 or at step 405. The structured circuit 304 serves as a Boolean-equivalent replacement for the original multi-gate logic structure 301. In various embodiments, the structured circuit may consolidate logic functions, reduce gate count, or improve signal propagation characteristics.

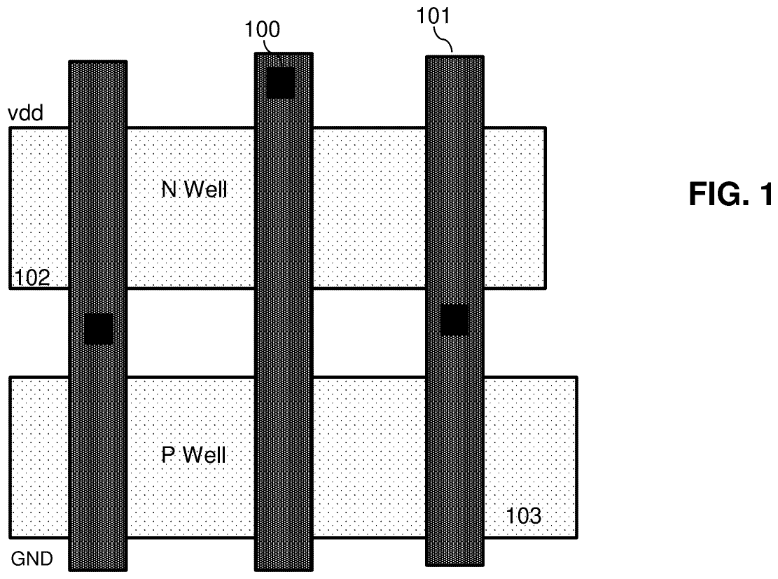

Referring to FIG. 1, generation of the structured circuit 304 may be constrained by a physical and device-level context 100. The physical context may include power supply connections 101 and 102, well structures 103 and 104, and one or more layer shape parameters 105. The layer shape parameters may define allowable geometric, spacing, enclosure, and connectivity constraints associated with a target semiconductor process.

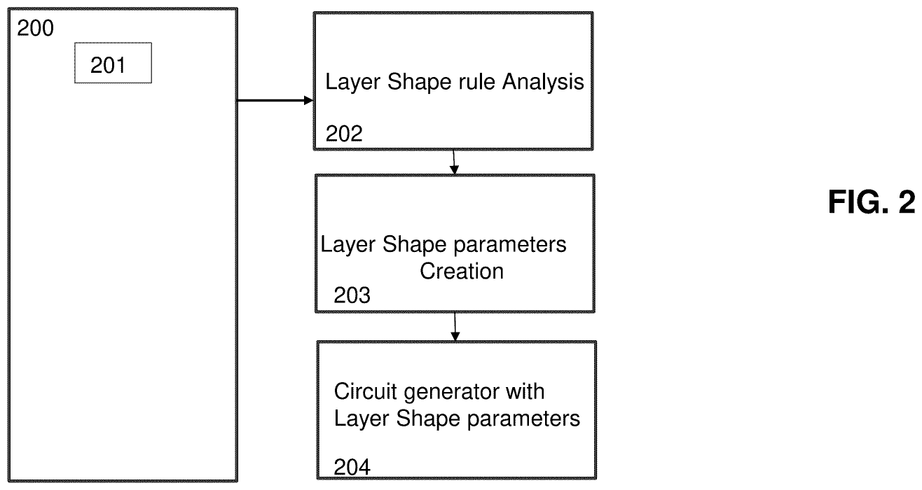

Referring to FIG. 2, a circuit generator 200 may receive the reduced Boolean representation 201 (or at step 405 of FIG. 4) and the associated layer shape parameters 105 and produce one or more candidate structured circuit implementations 202. In various embodiments, the layer shape parameters may be derived from qualified standard-cell libraries, extracted from previously manufactured designs, generated using rule-based techniques, or learned from historical layout data. Layer shape parameters are created at box 203 and a circuit generator with layer shape parameters is represented at box 204.

Following generation, the structured circuit 304 or at step 406 in FIG. 4 may be validated prior to replacement. Validation may include Boolean equivalence checking, timing characterization, power estimation, and physical verification, including design rule checking. Validation ensures that the structured circuit satisfies functional and physical requirements before integration into the digital circuit.

Upon validation, the structured circuit 304 or at step 406 in FIG. 4 may replace the corresponding reusable logic structure 301 or at step 403 within the digital circuit. Replacement may be performed incrementally and localized to affected regions of the design, thereby minimizing disruption to unrelated portions of the circuit.

In various embodiments, the process may be iterated using a decision loop at step 407 in FIG. 4 to determine whether one or more optimization objectives have been met. Additional reusable logic structures may be identified, reduced, and replaced until desired optimization targets are achieved. If the area/performance/power targets are not met, the processes can revert back to step 403. If the area/performance/power targets are met, the process ends.

Structured circuits generated using the V-ILC methodology may be stored in a repository along with associated metadata, including Boolean representations, timing models, power models, and physical parameters. Stored structured circuits may be reused in subsequent digital circuit designs to further improve efficiency and consistency across projects.

### Embodiments of Intelligent Layer Compression

In embodiments, the VIEE Intelligent Layer Compression (V-ILC) methodology provides a systematic process for identifying, reducing, and physically realizing reusable logic structures within a digital circuit while preserving Boolean equivalence and manufacturability.

Referring to FIG. 4, a multiple gate Verilog model may be parsed at step 402, and a digital circuit may be provided in the form of a multi-gate logic description at step 401 (e.g., build logical graph of all gates and connections). The multi-gate logic description may comprise a gate-level netlist generated through conventional synthesis or obtained from an existing placed-and-routed design. The logic description is parsed to construct a logical graph 402 in which nodes represent logic gates and edges represent signal interconnections.

The logical graph at step 402 is analyzed to identify reusable logic structures 403. In the preferred embodiment, reusable logic structures comprise groups of interconnected logic gates forming functional subgraphs along logic paths of varying depth. Identification may be based on structural repetition, timing criticality, power significance, or combinations thereof.

Once a reusable logic structure at step 403 is selected, a Boolean representation at step 404 corresponding to the identified logic structure is derived e.g., a Boolean Reduction on equation is run). The Boolean representation captures the functional behavior of the multi-gate structure independent of its original gate-level implementation. The Boolean representation is then reduced using one or more Boolean minimization techniques to generate a reduced Boolean representation at step 405 that preserves functional equivalence while reducing logical complexity (e.g., Map a new Boolean equation to a single circuit).

Referring to FIG. 3, a structured circuit 304, e.g., NOR gate 304 is generated to implement the reduced Boolean representation 303, e.g., NOR gate 303, or at step 405 of FIG. 4. The structured circuit serves as a Boolean-equivalent replacement for the original multi-gate logic structure 301. The system will include a circuit generator with layer shape parameters 305 which can generate the custom logic reduced equivalent gate at box 306 of the different gates 300-304.

Referring to FIG. 1, generation of the structured circuit 304 is constrained by a physical and device-level context 100 that includes power supply connections 101 and 102, well structures 103 and 104, and one or more layer shape parameters 105. The layer shape parameters define allowable geometric, spacing, enclosure, and connectivity constraints associated with a target semiconductor process.

Referring to FIG. 2, a circuit generator 200 receives the reduced Boolean representation and the associated layer shape parameters and produces one or more candidate structured circuit implementations 202 that satisfy both the specified Boolean functionality and the physical constraints imposed by the layer shape parameters.

Following generation, the structured circuit 304 is validated to confirm Boolean equivalence with the original reusable logic structure and compliance with applicable physical design constraints. Upon validation, the structured circuit replaces the corresponding reusable logic structure in the digital circuit.

The process may be iterated using decision loop at step 407 of FIG. 4 until one or more optimization objectives, including area reduction, performance improvement, or power reduction, are achieved.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

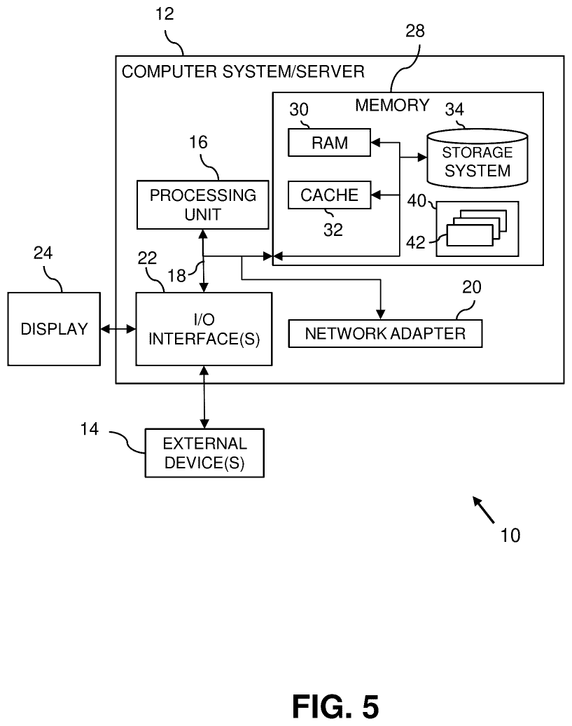

The computer readable program instructions may be provided to a processor of a computer (such as shown in FIG. 5), or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus (as shown in FIG. 5), or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 5, a schematic of an example of a computer infrastructure is shown. Computer infrastructure 10 is only one example of a suitable computer infrastructure and is not intended to suggest any limitation as to the scope of use or functionality of embodiments of the invention described herein. Regardless, computer infrastructure 10 is capable of being implemented and/or performing any of the functionality set forth hereinabove.

In computer infrastructure 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system 12 in computer infrastructure 10 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is claimed:

1. A computer-implemented method for optimizing a digital circuit design, comprising:
parsing a gate-level representation of the digital circuit design into a graph representation;
identifying, within the graph representation, a plurality of candidate logic structures each comprising a recurring multi-gate subgraph;
selecting at least one candidate logic structure of the plurality of candidate logic structures for optimization based on one or more optimization criteria;
deriving a Boolean representation for the selected candidate logic structure;
performing Boolean reduction on the Boolean representation to produce a reduced Boolean representation;
generating a structured gate configured to implement the reduced Boolean representation; and
replacing an instance of the selected candidate logic structure in the digital circuit design with the structured gate to produce an optimized digital circuit design.

2. The computer-implemented method of claim 1, wherein identifying the plurality of logic structures comprises identifying two-level logic structures referred to as Twigs.

3. The computer-implemented method of claim 2, wherein identifying the plurality of logic structures further comprises identifying multi-level logic structures formed from interconnected Twigs.

4. The computer-implemented method of claim 1, wherein selecting the at least one logic structure comprises analyzing timing data associated with the digital circuit design and prioritizing logic structures associated with critical timing paths.

5. The computer-implemented method of claim 1, wherein the one or more optimization criteria comprise at least one of timing impact, power impact, silicon area impact, switching activity, or congestion.

6. The computer-implemented method of claim 1, further comprising canonicalizing the candidate logic structures such that logically equivalent candidate logic structures are identified as equivalent independent of placement or orientation within the digital circuit design.

7. The computer-implemented method of claim 6, wherein canonicalizing comprises at least one of converting the Boolean representation to a canonical form, performing topological normalization, or performing graph isomorphism detection.

8. The computer-implemented method of claim 1, wherein generating the structured gate comprises generating the structured gate subject to one or more constraints associated with a target technology, the one or more constraints comprising at least one of physical design constraints, manufacturability constraints, or electrical constraints.

9. The computer-implemented method of claim 1, further comprising validating the structured gate prior to replacing the instance, wherein validating comprises at least one of logic equivalence checking, timing characterization, power estimation, or physical verification including design rule checking.

10. The computer-implemented method of claim 1, wherein replacing the instance comprises performing an incremental replacement localized to an affected region of a physical layout.

11. The computer-implemented method of claim 1, further comprising storing, in a repository, the structured gate and associated metadata for reuse in a subsequent digital circuit design.

12. The computer-implemented method of claim 11, wherein the associated metadata comprises at least one of a Boolean representation, a timing model, a power model, or physical parameters.

13. A system for optimizing a digital circuit design, comprising:
one or more processors; and
one or more non-transitory computer-readable storage media storing instructions that, when executed by the one or more processors, cause the system to perform the method of claim 1.

14. A non-transitory computer-readable medium storing instructions that, when executed by one or more processors, cause the one or more processors to perform the method of claim 1.

15. The computer-implemented method of claim 1, wherein candidate logic structures comprise candidate reusable logic structures.

16. A method comprising:
selecting a subset of a logic device layout;
generating Boolean equations from the subset of a logic device layout;
performing a Boolean reduction on the Boolean equations to obtain a Boolean reduced function;
generating a new logic device layout which is equivalent to the subset of the logic device layout from the Boolean reduced function.

17. The method of claim 16, wherein the new logic device layout is a reduced layout of the subset of the logic device layout.

18. The method of claim 17, wherein the Boolean reduced function comprises equivalent functionality as the subset of the logic device layout.
